(19) United States
(12) Patent Application Publication
(10) Pub. No.: US 2003/0067469 A1
(43) Pub. Date: Apr. 10, 2003

(54) Inklayer image with transparency

(76) Inventor: Atousa Soroushi, North Vancouver (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/243,608

(22) Filed: Sep. 13, 2002

Related U.S. Application Data
(60) Provisional application No. 60/328,290, filed on Oct. 9, 2001.

(51) Int. Cl. G06F 12/00; G06F 13/14; G09G 5/00; G09G 5/02

(52) U.S. Cl. 345/519; 345/592

(57) ABSTRACT

An inklayer image transparency system of the present invention has a graphics controller or processor, memory, and a display device that may be external to the inklayer image transparency system. The graphics controller is suitable for receiving signals (e.g. an address signal and a transparency control signal) and for providing image information to the display device. The memory is divided into at least two memory sections including a first memory section for storing foreground image information and a second memory section for storing background image information. A single address signal received by the graphics controller is used for simultaneously fetching the foreground image information from the first memory section and the background image information from the second memory section. A transparency control signal having a nontransparent state and a transparent state is used to control whether the foreground image or background image is displayed. The foreground image information is sent for display on the display device when the transparency control signal is in the nontransparent state and the background image information is sent for display on the display device when the transparency control signal is in the transparent state.

The present application is based on, and claims priority from, provisional application serial No. 60/328,290, filed Oct. 9, 2001, and is hereby incorporated herein by reference.

### BACKGROUND OF INVENTION

The present invention is directed to a method for implementing inklayer images with transparency logic as well as for apparatus for implementing inklayer images with transparency logic.

Inklayer design is the process of supporting a foreground image (the “inklayer”) that is overlaid on a background image. In the past, this may have been done by calling up the information for a particular foreground image, the information for a particular background image, or both the information for a particular foreground image and a particular background image. The foreground and background information would have to be addressed separately.

SRAM (Static Random Access Memory) is a kind of random access memory that requires a constant supply of power in order to hold its content, but does not require refresh circuitry as dynamic random access memory (DRAM) does. Each static RAM bit is a flip-flop circuit made of cross-coupled inverters; the activation of transistors controls the flow of current from one side to the other. Unlike read-only memory (ROM), SRAM will lose its content when the power is switched off. SRAM is usually faster than DRAM because it does not need to be refreshed, but takes up more space and uses more power. SRAM is used for the parts of a computer that require highest speed, such as cache memory.

U.S. Pat. No. 6,173,356 B1 to Rao (the “Rao reference”) discloses the concept of having multiple SRAM registers residing in a single address space. The Rao reference is directed to general systems and methods that use integrated memory that is comprised of a plurality of SRAM arrays and DRAM. In one embodiment, multiple SRAM registers of each bank could be considered as residing in a single address space. This reference, however, does not address the concerns of the present invention.

There are known methods for texture mapping in which a source image, referred to as a texture, is mapped (or overlayed) onto a surface of a three-dimensional object, and thereafter mapping the textured three-dimensional object to the two-dimensional graphics display screen to display the resulting image. This process involves applying one or more point elements (texels) of a texture to each point element (pixel) of the displayed portion of the object to which the texture is being mapped. References directed to texture mapping include U.S. Pat. Nos. 5,790,130, 6,011,565, 6,104,418, and 6,130,680. Most of these references deal, to some extent, with the problem of memory and how to access it. U.S. Pat. Nos. 5,828,382 and 6,204,863 B1 to Wilde (the “Wilde references”) are specifically directed to a method and apparatus for dynamic XY tiled texture caching. The Wilde references also disclose that internal SRAM memory can be divided into a number of cache tiles (ways). These references, however, are nonanalogous and do not address the concerns of the present invention.

### BRIEF SUMMARY OF THE INVENTION

The present invention is directed to the concept of being able to access a divided SRAM memory using a single address to simultaneously fetch background image information (written in the lower addresses) and foreground image information (written in the upper addresses).

An inklayer image transparency system of the present invention preferably includes a graphics controller or processor, internal or external memory, and a display device that may be external to the inklayer image transparency system. More specifically, the inklayer logic within the graphics controller is preferably suitable for receiving signals (e.g. an address signal and a transparency control signal) and for providing image information to the display device. The memory is preferably divided into at least two memory sections including a first memory section for storing foreground image information and a second memory section for storing background image information. In one preferred embodiment of the present invention, a single address signal received by the graphics controller is used for simultaneously fetching the foreground image information from the first memory section and the background image information from the second memory section. In one preferred embodiment of the present invention, a transparency control signal having a nontransparent state and a transparent state such that the foreground image information is sent for display on the display device when the transparency control signal is in the nontransparent state and the background image information is sent for display on the display device when the transparency control signal is in the transparent state.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIGS. 1A and 1B are a schematic block diagram of an exemplary circuitry, including a divided SRAM memory, of the present invention.

FIG. 2 is a high-level flowchart of an exemplary method of implementing the concept of being able to access a divided SRAM memory using a single address to simultaneously fetch background image information (in the lower addresses) and foreground image information (in the upper addresses).

FIG. 3 is a high-level flowchart of an exemplary method of determining whether foreground image information or background image information will be sent to the display.

### DETAILED DESCRIPTION OF THE INVENTION

The present invention is directed to the concept of being able to access a divided SRAM memory using a single address to simultaneously fetch a first type of information from a portion of the divided SRAM addresses (e.g. in the lower addresses) and a second type of information from a separate portion of the divided SRAM addresses (e.g. in the upper addresses). A broad implementation of the present invention would include using the portion of the divided SRAM addresses of memory to address a particular type of information and the opposite portion of the divided SRAM addresses of memory to address a separate type of information. One preferred embodiment of the present invention is directed to applying this concept to the concept of inklayer transparencies having foreground and background images.

For purposes of simplicity, throughout this disclosure, the present invention is discussed in terms of fetching background image information in the lower addresses and foreground image information in the upper addresses, this could be modified so that background image information is fetched from the upper addresses and foreground image information is fetched from the lower addresses. Still further, the present invention could be implemented by fetching background image information from any portion of the divided SRAM addresses and foreground image information the opposite portion of the divided SRAM addresses. The present invention could be implemented with more than two memory sections and multiple layers of image information. The multiple layer implementation would require evenly divided memory sections.

As set forth in the Background, inklayer design is the process of supporting a foreground image (the “inklayer”) that is overlaid on a background image. In the past, this may have been done by calling up either or both of the information for a particular foreground and/or background image. The foreground and background information would have to be addressed separately.

One significant feature of a preferred embodiment of the present invention is that a single address calls up two 32 bit words, one for foreground image information and one for background image information. The information can then be compared and, if desired, the foreground pixel can be replaced by the background pixel. This is accomplished by dividing SRAM memory into at least two sections, the foreground image information is written in the lower addresses and the background image information is written in the upper addresses. Alternatively, this could be reversed. It should be noted that using the present invention, both the foreground and the background image information could be updated independently.

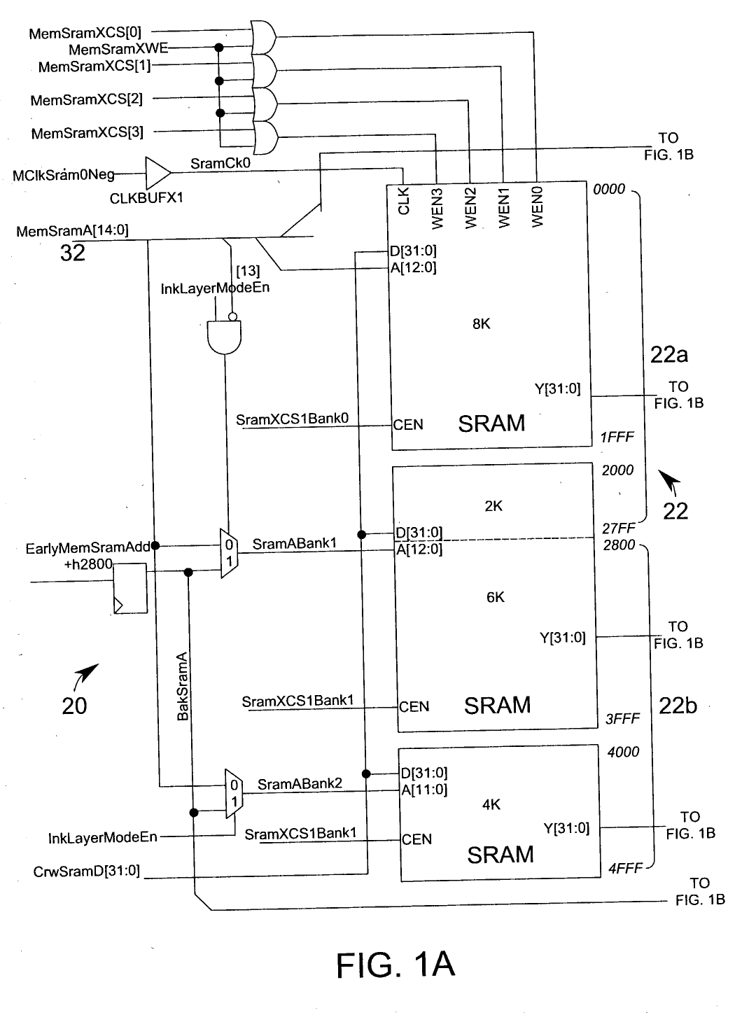

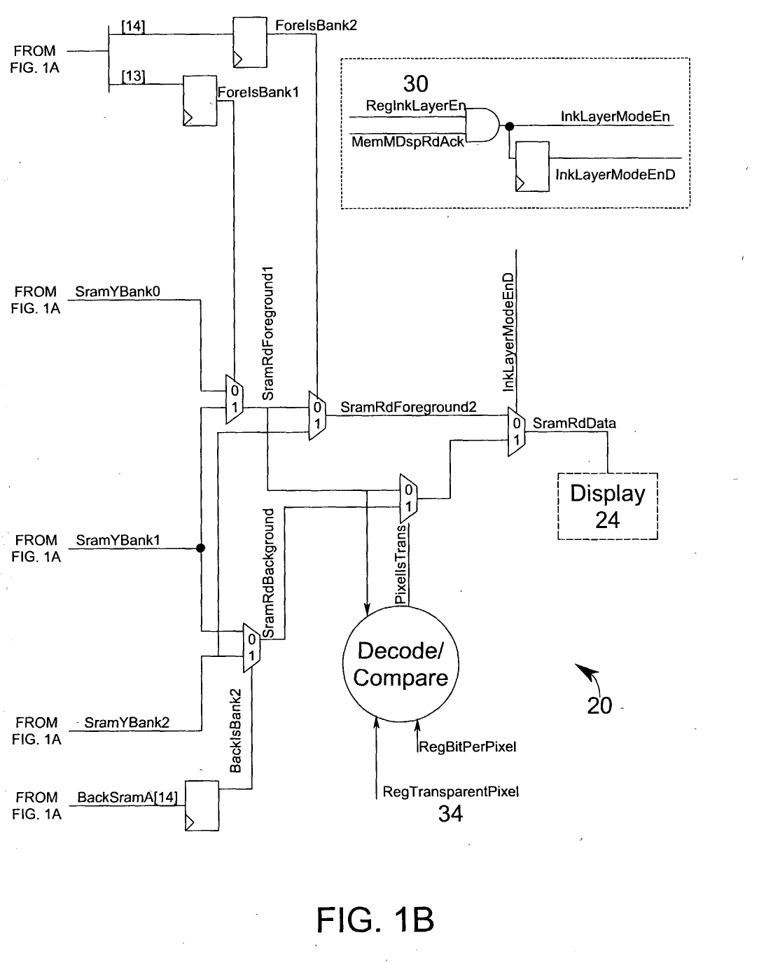

As shown on FIGS. 1A-1B, an inklayer image transparency system of the present invention preferably includes a graphics controller, memory controller, or processor 20 (hereinafter referred to as “graphics controller 20”), internal or external memory 22, and a display device 24 that may be external to the inklayer image transparency system. More specifically, the inklayer logic within the graphics controller 20 is preferably suitable for receiving signals (e.g. an inklayer enable signal 30, an address signal 32, and a transparency control signal 34) through an interface from a CPU or other signal producing mechanism. The graphics controller is also preferably suitable for providing image information to the display device 24. The memory 22 is preferably divided into at least two memory sections including a first memory section 22a for storing foreground image information and a second memory section 22b for storing background image information. In one preferred embodiment of the present invention, a single address signal 32 received by the graphics controller 20 is used for simultaneously fetching the foreground image information from the first memory section and the background image information from the second memory section. In one preferred embodiment of the present invention, a transparency control signal 34 having a nontransparent state (e.g. InkLayerModeEn=0) and a transparent state (e.g. InkLayerModeEn=1) such that the foreground image information is sent for display on the display device 24 when the transparency control signal is in the nontransparent state and the background image information is sent for display on the display device 24 when the transparency control signal is in the transparent state.

FIGS. 1A and 1B show a detailed exemplary embodiment of the present invention. Alternate exemplary embodiments are discussed herein. Additional embodiments may include combinations of the features discussed, additional features not discussed, and variations that those skilled in the art could ascertain from this specification.

It should be noted that the inklayer mode may be selectively enabled and disabled. The inklayer mode is enabled only when the inklayer enable register (RegInkLayerEn 30) is set and when the pixels are fetched from the SRAM to display. When the inklayer mode is enabled, as will be discussed below, the memory is divided. When the inklayer mode is disabled, foreground image information may occupy the entire memory. This allows the image to be twice as big as the image is when the inklayer mode is enabled. Further, when the inklayer mode is disabled, no comparison will be done. The image is sent to the display device 24 as SramRdData.

The memory 22 is preferably divided into at least two memory sections including a first memory section 22a for storing foreground image information and a second memory section 22b for storing background image information. When the inklayer mode is enabled, the SRAM is divided into two memory sections of 10K words. In this embodiment the foreground image information is written in to the lower 10K words (e.g. 0000-27FF in word address or 0000-9FFF in byte address) and the background image information is written in the upper 10K words (e.g. 2800-4FFF in word address or A000-13FF in byte address). In the shown exemplary embodiment of FIGS. 1A and 1B, there is 20K (multiplied by 32 bits) of SRAM which physically divided into a first bank of 8K, a second bank of 8K, and a third bank of 4K. This physical layout is then divided into the first memory section (consisting of 8K from the first bank and 2K from the second bank) the second memory section (consisting of 6K from the second bank and 4K from the third bank). Preferably, the memory is divided into equal sections. In the shown embodiment the division is predetermined, but in alternate embodiments the division could be programmable. In a programmable embodiment the hardware could read the value (the size of the memory sections) from a register and add that value to the MemSramA (instead of 2800h).

In the shown embodiment, the foreground video buffer contains the inklayer pixels and a transparent pixel code for every pixel that needs to be transparent. The user or programmer defines the transparent pixel code (transparency control signal RegTransparentPixel 34) in a specified register thereof.

A single address signal 32, MemSramA[14:0] is received by the graphics controller 20. The single address signal 32 is then used for simultaneously fetching the foreground image information from the first memory section and the background image information from the second memory section. In the shown exemplary embodiment of FIGS. 1A and 1B, there is 20K (multiplied by 32 bits) of SRAM. The SRAM is addressed by decoding 15 bits of address MemSramA[14:0] to decode addresses 0000-4FFF. In the embodiment shown, if MemSramA[14:13]=00, the first bank of 8K (0000-1FFF) is being addressed, if MemSramA[14:13]=01, the second bank of 8K (2000-3FFF) is being addressed, and if MemSramA[14]=1, the third bank of 4K (4000-4FFF) is being addressed.

In the shown embodiment, EarlyMemSramAdd is the address of MemSramA with 2800h (or the size of the foreground memory) added to it. In other words, if MemSramA is 0000, EarlyMemSramAdd is 2800h. If MemSramA is 27FF, EarlyMemSramAdd is 4FFF. If the inklayer mode (InkLayerModeEn) is enabled, EarlyMemSramAdd is output through the 2 to 1 multiplexers to access the appropriate SRAM memory location for the Background pixels. EarlyMemSramAdd is same as MemSramA, just one clock earlier. The early version is used so that with the ADDER's (+2800h) delay the resulting address is synchronous with the data going to the SRAM.

To make this addressing possible, in the embodiment shown in FIGS. 1A and 1B, a plurality of FlipFlops (FF) and Multiplexers (Mux) are used. It should be noted that the shown specific mechanisms are meant to be exemplary and could be adapted, for example, by replacing them with equivalent circuit elements, to accommodate different memory and word sizes, and to adjust connections accordingly. However, for purposes of illustration, one of the multiplexers (Mux) has the specific purpose of connecting the original MemSramA[12:0]+2800h to select the background color, only if the inklayer mode is enabled and the display pipe is accessing the first 8K of the first bank (A[13]=0), otherwise, it uses the original MemSramA[12:0] to access the second bank. However, if the inklayer mode is enabled and the display pipe is accessing address 2000-27FF (A[13]=1), it is accessing foreground data in the second bank so that original address is shown as connected to the second bank. If the inklayer mode is enabled and the display pipe is accessing the third bank (4000-4FFF), the intention is to access the background data, so MemSramA[12:0]+2800h is connected to the third bank. (In the shown embodiment, the third is always accessed by the original address if the inklayer mode is disabled and by MemSramA[12:0]+2800h if the inklayer mode is enabled.

Once the memory has been accessed and both foreground and background image information has been simultaneously fetched, the appropriate information is determined. Then, if the inklayer mode is enabled, the foreground image information is sent forward to be compared to the background image information. In the shown embodiment, if ForelsBank1 is 0, the data from the first SRAM bank is sent forward, but if ForelsBank1 is 1, the data from the second SRAM bank is sent forward. The data sent forward is SramRdForeground1. Further, in the shown embodiment, if BackIsBank2 is 0, the data from the second SRAM bank is sent forward, but if BackIsBank2 is 1, the data from the third SRAM bank is sent forward. The data sent forward is SramRdBackground.

In the shown embodiment, the transparency control signal RegTransparentSignal 34 may indicate either a nontransparent state or a transparent state. If the transparency control signal indicates the nontransparent state, the foreground image information is sent for display on the display device 24. When the transparency control signal 34 is in the transparent state, the background image information is sent for display on the display device 24. In FIGS. 1A and 1B this is shown as every pixel of foreground being compared with the transparency control signal, as set in the RegTransparentPixel. If the foreground pixel is transparent it is replaced with its corresponding fetched background pixel and the result is sent to the display pipe, as bit SramRdData, to be displayed on the display device 24.

For exemplary purposes, the embodiment shown in FIGS. 1A and 1B is detailed. The following should be noted about this detailed example:

Bank selection for foreground and background data is using MemSramA/BackSramA [14:13]. The bank select signals are one clock (clk) delayed from MemSramA because MemSramA changes a half Mclk before the read data needs to be sampled.

MemSramRdAck which makes the InkLayerModeEn, is one MClk long and is deasserted 1 MClk before SramRdData is being sampled. So, 1 MClk delayed version of Address Decode and InkLayerModeEn are used to Mux foreground or background to SramRdData at the output.

InkLayerEn is used when display interface is reading from memory. In other words when RegInkLayerEn is set and display interface reads from memory (and memory sends MemMDspRdAck to display pipe), the display interface can only access the first half of memory (but the interface sees the second half of memory if the first half is transparent). When any other (i.e. CPU) interface is reading from/writing to memory, however, the interface sees the memory as one whole piece and can access all of it (independent of whether RegInkLayerEn is set or not). Therefore CPU can write all foreground and background data in memory. CrwSramD[31:0] is the write data from the CPU or other signal provider.

InkLayerModeEn is used to multiplex an address to SRAM (pre-SRAM). InkLayerModeEnD is a clock delayed version of InkLayerEn that may be used to select the read data (output if SRAM), since output of SRAM is a clock delayed from its Address.

MemSramXCS[0] through [3] is used to provide the option to write only 8, 16, or 32 bit of every 32 bits of memory. For example, if MemSramXCS[3:0]=0001, only the first lower bits of each 32 bits will be written.

SramXCS1Bank0 and SramXCS1Bank1 are the chip selects for each bank, decoded from A[14:13].

PixellsTrans selects whether SramRdBackground or SramRdForeground1 will be sent to the final multiplexor.

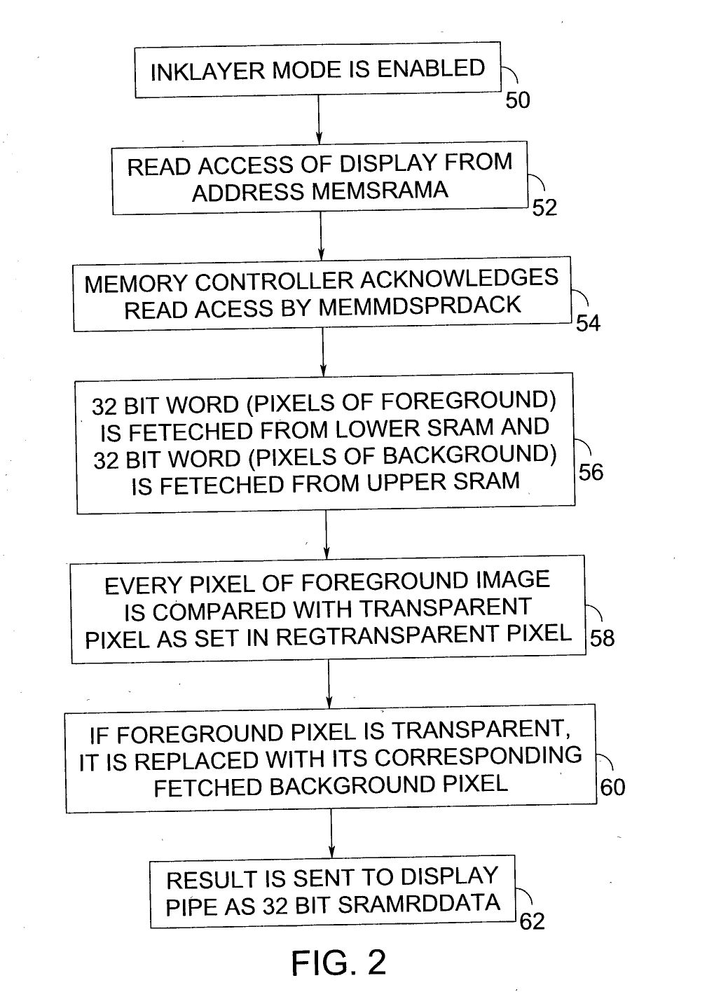

FIG. 2 shows an exemplary method of the present invention. The first step is determining that an inklayer mode is enabled 50. Then, there is a read access of the display from the address MemSramAdd 52. Then the graphics controller may acknowledge the read access 54. Every read access of display from address MemSramAdd, which is acknowledged by the graphics controller by MemMDspRdAck, will fetch two 32 bit words from the SRAM. One from the lower 10K at [MemSramA] as SramRdForeground1, and one from the upper 10K at [MemSramA+2800h] as SramRdBackground 56. Each 32 bit word may contain several pixels (based on RegBitPerPixel). Next, every pixel of foreground image is compared with the transparent pixel control (transparency control signal 34 as set in RegTransparentPixel) 58 whether the first information or the second information is to be displayed on the display device 24. If the foreground pixel is transparent, it is replaced with its corresponding fetched background pixel 60. The resulting graphic display signal SramRdData is then sent to the display device 62.

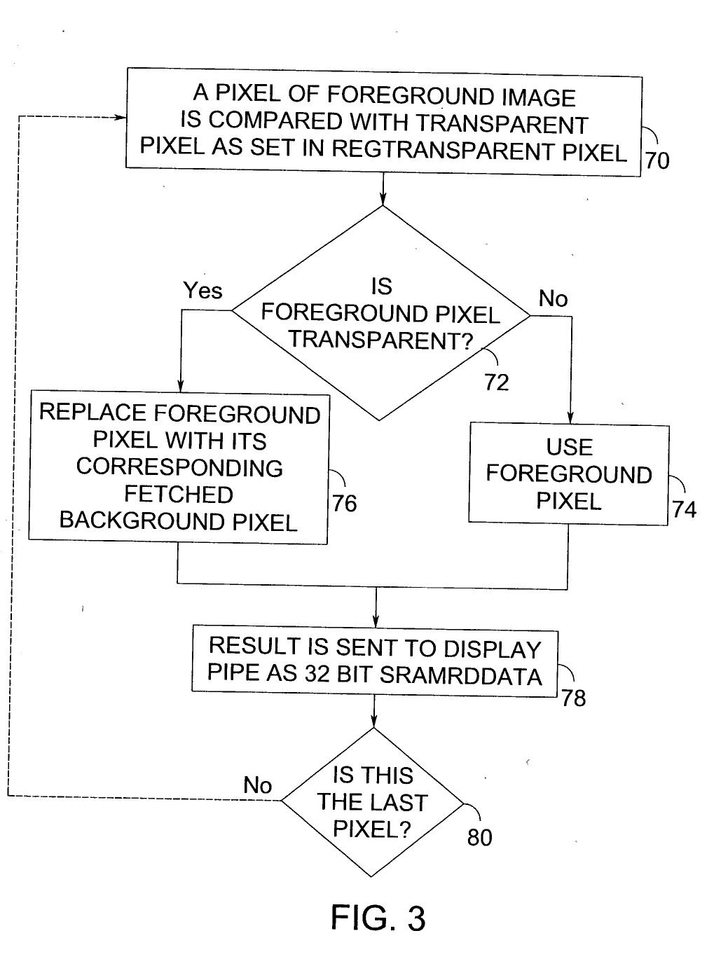

FIG. 3 is a high-level flowchart of an exemplary method of determining whether foreground image information or background image information will be sent to the display device 24. It should be noted that although it is not shown in this figure, the fetched two 32 bit words from the SRAM may contain several pixels (based on RegBitPerPixel). In this figure, the first step is comparing a pixel of foreground image the transparency control signal 34 as set in RegTransparentPixel 70 to determine whether it is transparent or not 72. If it is not transparent, the foreground pixel is used 74. If it is transparent, the foreground pixel is replaced with its corresponding fetched background pixel 76. The result is then sent to the display pipe as 32 bit SramRdData 78 for display on the display device 24. Each pixel is then examined 80. (The decision box “Is this the last pixel” 80 is actually display pipe logic, but the step would be applied for every read from memory, CPU, or display pipe.)

It should be noted that the graphics controller, memory controller, or processor 20 described herein may be a standalone unit (such a single chip) or may be incorporated into a larger system. It should be noted that the types of circuit elements may be replaced with equivalent circuit elements and the connections may be adjusted accordingly. It should be noted that the exemplary sizes discussed above, such as the memory and word sizes, may be adjusted without affecting the scope of the invention and that the circuit elements may be adjusted to accommodate the size adjustments. It should be noted that signals such as the address signals may be generated from within the graphics controller (for example, from a display pipe to a memory controller) or from an external source.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. An inklayer image transparency system for use with an external system, wherein said external system includes at least one display device for displaying at least one image using a plurality of pixels, said inklayer image transparency system comprising:
(a) a controller suitable for receiving signals and for providing image information to said display device;
(b) for each pixel of said plurality pixels, at least one of said signals being an address signal and at least one of said signals being a transparency control signal;
(c) memory functionally associated with said controller;
(d) said memory divided into at least two memory sections including a first memory section and a second memory section;
(e) said first memory section for storing foreground image information for display on said display device;
(f) said second memory section for storing background image information for display on said display device;
(g) said address signal for simultaneously fetching said foreground image information from said first memory section and said background image information from said second memory section; and
(h) said transparency control signal having a nontransparent state and a transparent state:
(i) said foreground image information being sent for display on said display device when said transparency control signal is in said nontransparent state; and
(ii) said background image information being sent for display on said display device when said transparency control signal is in said transparent state.

2. The inklayer image transparency system of claim 1 wherein said controller and said memory are on a single chip.

3. The inklayer image transparency system of claim 1 wherein said controller is separate from said memory.

4. The inklayer image transparency system of claim 1 wherein said memory is Static Random Access Memory.

5. The inklayer image transparency system of claim 1 wherein said first memory section and said second memory section are independently updatable.

6. The inklayer image transparency system of claim 1 wherein said first memory section is an upper memory section and said second memory section is a lower memory section.

7. The inklayer image transparency system of claim 1 wherein said first memory section is a lower memory section and said second memory section is an upper memory section.

8. The inklayer image transparency system of claim 1 wherein said first memory section has a first memory section size and said second memory section has a second memory section size, said first memory section size being equal to said second memory section size.

9. The inklayer image transparency system of claim 8 wherein said first memory section size and said second memory section size are programmable.

10. A system comprising:
(a) a display device for displaying at least one image having a plurality of pixels;
(b) a processor suitable for receiving signals and for providing information to said display device;
(c) for each pixel of said plurality pixels, at least one of said signals being an address signal and at least one of said signals being a control signal;
(d) memory functionally associated with said processor;
(e) said memory divided into at least two memory sections including a first memory section and a second memory section;
(f) said first memory section for storing first information for display on said display device;
(g) said second memory section for storing second information for display on said display device;
(h) said address signal for simultaneously fetching said first information from said first memory section and said second information from said second memory section; and
(i) said control signal for controlling whether said first information or said second information is displayed on said display device.

11. The system of claim 10 wherein said memory is Static Random Access Memory.

12. The system of claim 10 wherein said first memory section and said second memory section are independently updatable.

13. The system of claim 10 wherein said first memory section is an upper memory section and said second memory section is a lower memory section.

14. The system of claim 10 wherein said first memory section is a lower memory section and said second memory section is an upper memory section.

15. The system of claim 10 wherein said first information is a foreground image and said second information is a background image.

16. The system of claim 10 wherein said first information is a background image and said second information is a foreground image.

17. The system of claim 10 wherein said first memory section has a first memory section size and said second memory section has a second memory section size, said first memory section size being equal to said second memory section size.

18. The system of claim 17 wherein said first memory section size and said second memory section size are programmable.

19. A controller for use with an external system, wherein said external system includes at least one display device for displaying at least one image having a plurality of pixels, said controller comprising:
(a) said controller suitable for receiving signals and for providing information to said display device;
(b) for each pixel of said plurality pixels, at least one of said signals being an address signal and at least one of said signals being a control signal;
(c) memory functionally associated with said controller;
(d) said memory divided into at least two memory sections including a first memory section and a second memory section;
(e) said first memory section for storing first information for display on said display device;
(f) said second memory section for storing second information for display on said display device;
(g) said address signal for simultaneously fetching said first information from said first memory section and said second information from said second memory section; and
(h) said control signal for controlling whether said first information or said second information is displayed on said display device.

20. The controller of claim 19 wherein said controller and said memory are on a single chip.

21. The controller of claim 19 wherein said controller is separate from said memory.

22. The controller of claim 19 wherein said memory is Static Random Access Memory.

23. The controller of claim 19 wherein said first memory section and said second memory section are independently updatable.

24. The controller of claim 19 wherein said first memory section is an upper memory section and said second memory section is a lower memory section.

25. The controller of claim 19 wherein said first memory section is a lower memory section and said second memory section is an upper memory section.

26. The controller of claim 19 wherein said first information is a foreground image and said second information is a background image.

27. The controller of claim 19 wherein said first information is a background image and said second information is a foreground image.

28. The controller of claim 19 wherein said first memory section has a first memory section size and said second memory section has a second memory section size, said first memory section size being equal to said second memory section size.

29. The controller of claim 28 wherein said first memory section size and said second memory section size are programmable.

30. A method for processing graphic display signals and displaying an image based on said graphic display signals on a display device, said display device having a plurality of pixels, said method comprising the steps of:
(a) providing a memory divided into at least two memory sections including a first memory section and a second memory section, said first memory section for storing first information for display on said display device, said second memory section for storing second information for display on said display device;
(b) for each pixel of said plurality of pixels:
(i) determining that an inklayer mode is enabled;
(ii) fetching simultaneously using a single address signal both said first information from said first memory section and said second information from said second memory section;
(iii) determining, based on a control signal, whether said first information or said second information is to be displayed on said display device as a resulting graphic display signal; and
(iv) sending said resulting graphic display signal to said display device.

31. The method of claim 24 wherein said step of determining whether said first information or said second information is to be displayed on said display device based on a control signal further comprises the step of determining whether said first information is transparent.
